(19) United States
(12) Patent Application Publication
(10) Pub. No.: US 2004/0166591 A1
(43) Pub. Date: Aug. 26, 2004

(54) Closed system for sampling of blood components

(76) Inventor: Peggy Niston, Yadkinville, NC (US)

Correspondence Address: BIRCH STEWART KOLASCH & BIRCH, PO BOX 747, FALLS CHURCH, VA, 22040-0747, US

(21) Appl. No.: 10/737,835

(22) Filed: Dec. 18, 2003

Related U.S. Application Data
(60) Provisional application No. 60/433,964, filed on Dec. 18, 2002.
(60) Provisional application No. 60/470,222, filed on May 14, 2003.

(51) Int. Cl. G01N 1/10

(52) U.S. Cl. 436/180; 422/100

(57) ABSTRACT

A device for taking a sample of material from a primary container includes a needle assembly, and intermediate container and a length of tubing. The needle assembly is connectable to a container for receiving a sample of material from the primary container. The intermediate container is connected to the needle assembly through a 3-way connector. The length of tubing is connected to the intermediate container and the needle assembly through the 3-way connector. The length of tubing is connectable to the primary container. With the above construction, material from the primary container is flowable through the length of tubing into the intermediate container and through the needle assembly to obtain a sample of the material into the container for receiving the sample.

### CROSS-REFERENCE TO RELATED APPLICATIONS

This application claims priority under 35 U.S.C. § 119 to U.S. Provisional Application Nos. 60/433,964 and 60/470,222, filed on Dec. 18, 2002 and May 14, 2003, respectively. The entirety of each of the above applications are incorporated herein by reference.

### BACKGROUND OF THE INVENTION

1. Field of the Invention:

The present invention is directed to a device for obtaining a sample of a material from a primary container. In particular, the present invention is directed to a device for obtaining a sample of material from within a closed system without contamination of the closed system.

### SUMMARY OF THE INVENTION

An object of the present invention is to obtain a sample of material from a closed system without contamination of the closed system.

Another object of the present invention is to design a system that allows for the transfer of a blood component from a primary container to a sampling container while maintaining a closed system. Therefore, the introduction of contaminants into the primary container is eliminated. Accordingly, the original outdate of the primary container can be maintained.

The above object of the present invention can be accomplished by a device for taking a sample of material from a primary container, comprising:

a needle assembly, said needle assembly being connectable to a container for receiving a sample of material from the primary container;

an intermediate container, said intermediate container being connected to said needle assembly through a 3-way connector; and

a length of tubing, said length of tubing being connected to said intermediate container and said needle assembly through said 3-way connector, said length of tubing being connectable to the primary container,

wherein material from the primary container is flowable through said length of tubing into said intermediate container and through said needle assembly to obtain a sample of the material into the container for receiving the sample.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is an explanatory view of the closed system for sampling of blood components of the present invention according to a first embodiment;

FIG. 2 is an explanatory view of the closed system for sampling of blood components of the present invention according to a modified version of the first embodiment;

FIG. 3 is an explanatory view of the closed system for sampling of blood components of the present invention according to a second embodiment;

FIG. 4 is a photograph of the modified embodiment of FIG. 2;

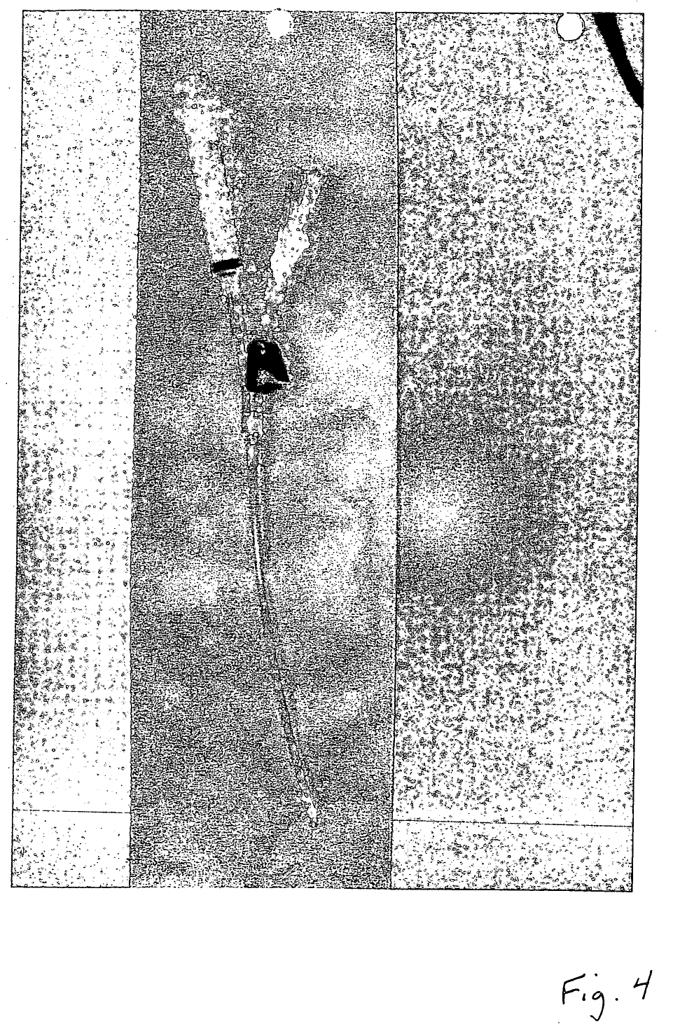

FIG. 5 is a close-up photograph of FIG. 4;

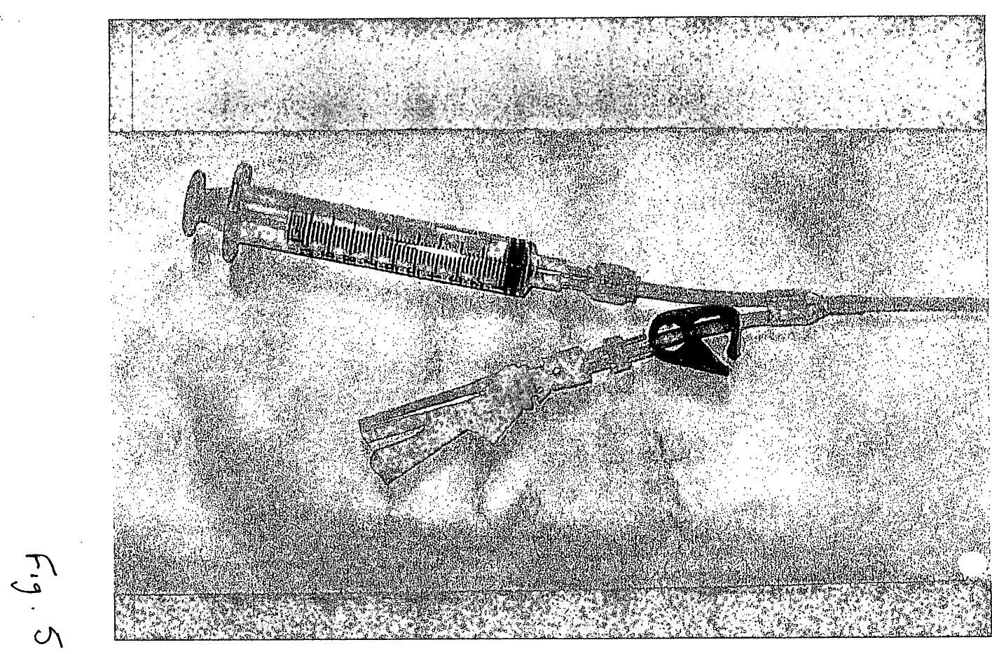

FIG. 6 is a photograph of the modified embodiment of FIG. 2, which includes a primary container attached thereto;

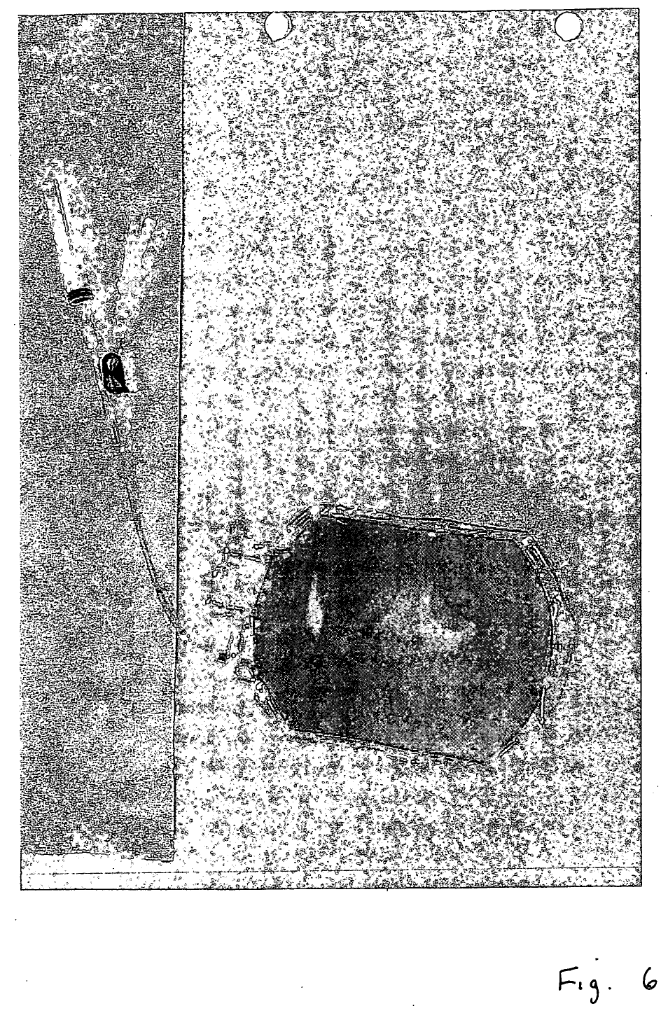

FIGS. 7 and 8 are photographs of the second embodiment of FIG. 3 of the present invention;

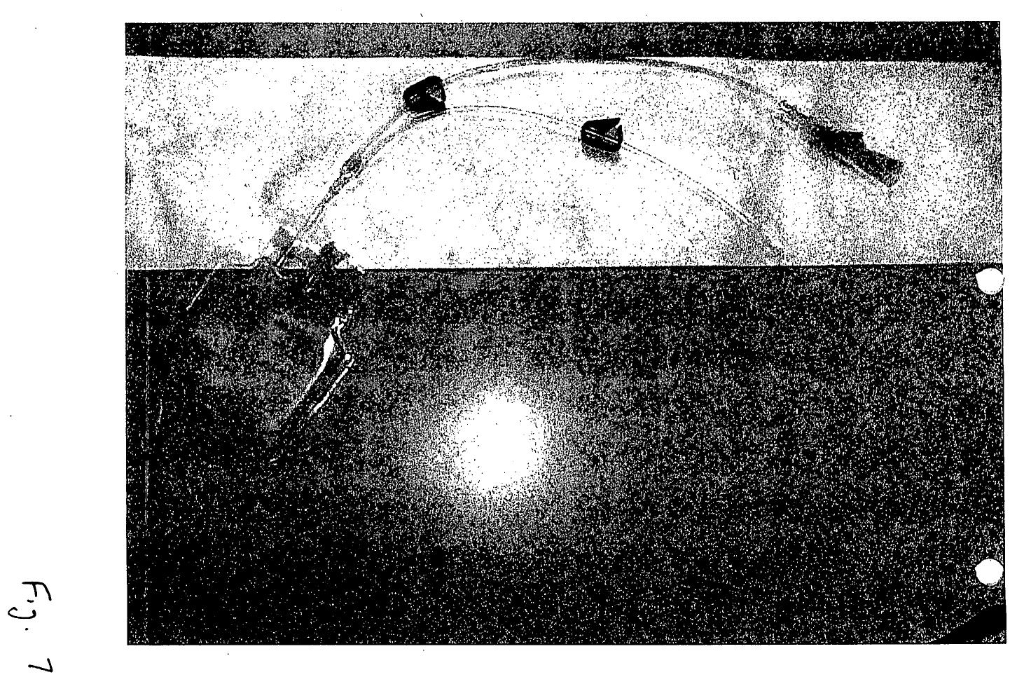

FIG. 9 is an alternative arrangement of the needle assembly of the first embodiment; and

FIG. 10 is an alternative arrangement of the needle assembly of the second embodiment.

### DETAILED DESCRIPTION OF THE PREFERRED EMBODIMENTS

The present invention will now be described with reference to the accompanying drawings, wherein the same reference numerals will be used to identify the same or similar elements throughout the several views. It should be noted that the drawings identify the preferred components to be used in the present invention; however, it will be readily understood to one having ordinary skill in the art that other similar components can be easily substituted.

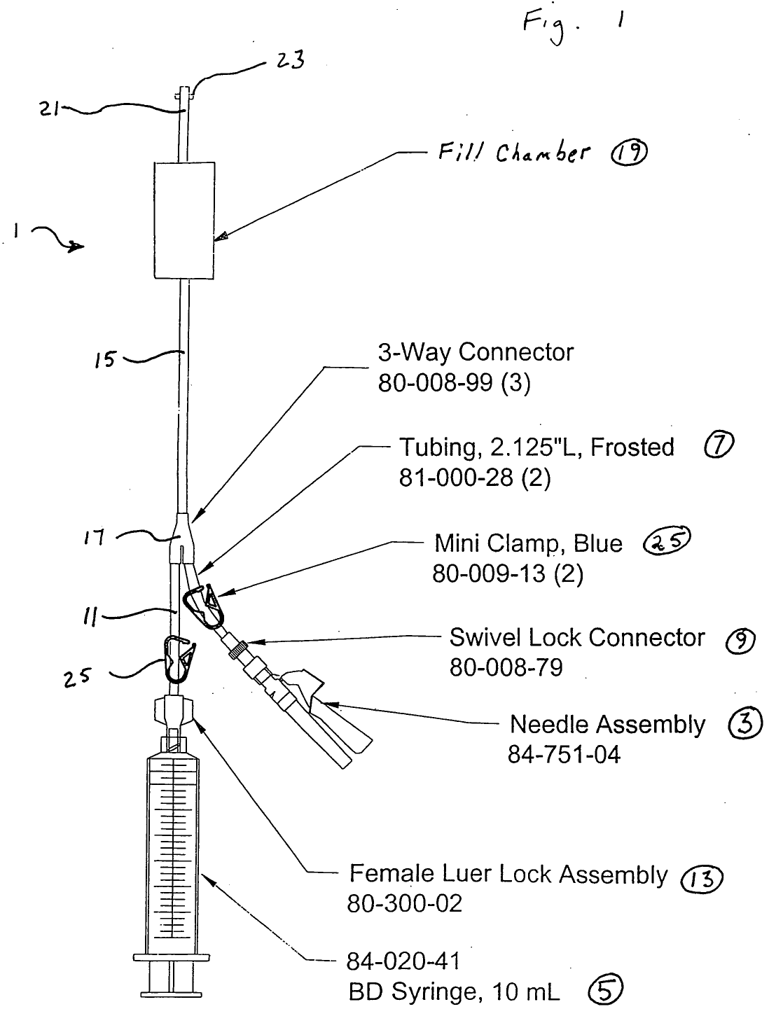

Referring to FIG. 1 of the present invention, a first embodiment of the closed system for sampling blood components of the present invention is illustrated. The device is generally identified by the reference numeral 1. The device 1 is attachable to a primary container, which contains a blood component, for example, platelets, concentrated red blood cells, blood, etc. The device 1 is pre-sterilized and can be attached to the primary container by a sterile docking device to ensure that the connection between the primary container and the device 1 remains sterile. A sterile docking device manufactured by Terumo is preferred; however, it should be understood that other docking devices could also be used.

The device 1 of the present invention includes a needle assembly 3 and a syringe 5. The needle assembly 3 is attached to a piece of tubing 7 by, for example, a swivel lock connector 9. The syringe 5 is also connected to a piece of tubing 11 by, for example, a female Luer lock assembly 13. The two pieces of tubing 7 and 11 are attached to another piece of tubing 15 by a 3-way connector 17. A fill chamber 19 is connected between the piece of tubing 15 and a piece of tubing 21. The piece of tubing 21 includes an RF weld 23 at an end thereof. A pinch clamp 25 is mounted to the pieces of tubing 7 and 11, respectively, in order to open and close the pieces of tubing. The device 1 is connectable to the primary container at the end of the tubing 21, which includes the weld 23.

An explanation of the first embodiment of the present invention will now be described. A sterile docking device receives an end of the tube 15, which includes the weld 23 and a welded end of a tube extending from the primary container. As is well known to those of ordinary skill in the art, the weld 23 and the weld on the tube extending from the primary container are cut off as the tubes are axially aligned and are welded together. The weld between the tube 15 of the device 1 and the tube extending from the primary container is a re-openable weld, which can be opened by an end user by merely pinching the weld. Once the device 1 is mounted to the primary container in the above manner and all connections are secure, an operator opens the weld between the tube 15 and the tube extending from the primary container to allow flow of material into the device 1. The fill chamber 19 is then squeezed to prime the device 1. The pinch clamp 25, which is mounted to the piece of tubing 11 is opened to allow the flow of material through the piece of tubing 11 and into the syringe 5. At this time, the syringe 5 is operated to fill the syringe with the material from the primary container.

Once a sufficient quantity of material is received into the syringe 5, the tubing 15 is then sealed by, for example, a heat seal or some other clamping device. For example, a dielectric sealer can be used to seal the tubing 15; however, it should be understood that other heat sealers or clamping devices are within the scope of the present invention. At this time, the cover on the needle assembly 3 is removed and the needle is inserted into a vacutainer or a sample vile. The pinch clamp 25 on the piece of tubing 7 is then opened to allow flow therethrough. Operation of the plunger of the syringe 5 forces the material out of the syringe 5, through the piece of tubing 11, through the 3-way connector 17 and into the piece of tubing 15. Since the piece of tubing 15 is sealed as mentioned above, the material then flows through the 3-way connector 17 again and into the piece of tubing 7. The material then flows through the needle assembly 3 and into the vacutainer or sample vile.

At this time, the needle of the needle assembly 3 can be removed from the vacutainer or sample vile to obtain a sample, which has not been contaminated. The device 1 can then be disconnected from the primary container and discarded without any contamination to the primary container. The disconnection from the primary seal can be performed by cutting the heat seal in the piece of tubing 15. This procedure separates the two components, while ensuring that the two components remain sealed to prevent contamination.

It should be noted that the above procedure does not have to be followed in the exact order described above. For example, the device 1 can be detached from the primary container prior to supplying the material into the vacutainer or sample vile. This procedure would typically be used for bacterial testing. Once the device 1 is disconnected, the device 1 can be brought to a testing station where the material from the syringe 5 is supplied into the vacutainer or sample vile. The vacutainer or sample vile is receivable in a testing device in order to perform a desired test to the material therein.

It should be noted at this time that the fill chamber 19 is not a necessary element of the device 1 of the present invention. As will be readily understood to one having ordinary skill in the art, the fill chamber 19 is merely used to prime the device 1. If a fill chamber is not utilized, the device 1 will still operate sufficiently, since the material will flow into the device 1 through the force of gravity when the weld 23 is opened and toward the syringe once the pinch clamp 25 is operated to open the piece of tubing 11. The fill chamber 19 can be used to limit the amount of air in the device 1 before the pinch clamp 25 is opened. However, if the fill chamber 19 is not included, any air that gets pulled into the syringe 5 can be pushed out by operating the plunger of the syringe. The air will merely flow up the tubing 11, 15 and 21 and into the primary container to allow space for additional material to be sucked into the syringe 5 through operation of the plunger. The flow of air into the primary container will not pose a risk of contamination of the material in the primary container, since the device 1 and the connection between the device 1 and the primary container are sterile.

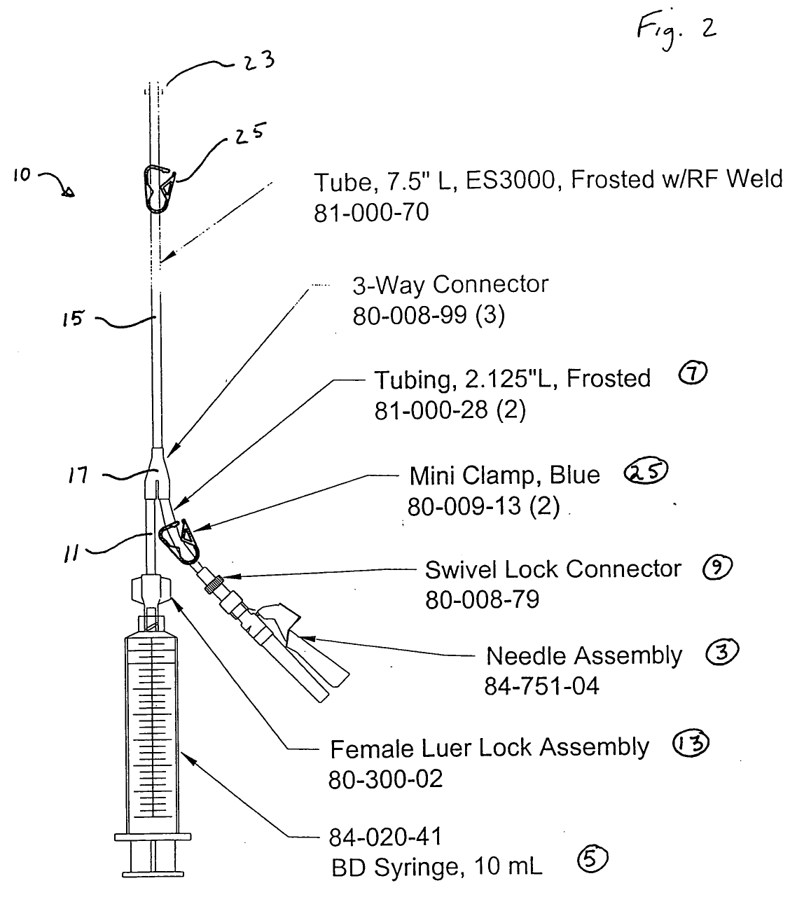

The above will be easily understood with reference to FIG. 2 of the present invention, which illustrates a modified form of the first embodiment. The device 10 includes a piece of tubing 15 with a weld 23 at an end thereof. A pinch clamp 25 is preferably mounted to the piece of tubing 15 in order to open and close the piece of tubing 15. It is unnecessary to provide a pinch clamp on the piece of tubing 11. Furthermore, the pinch clamp 25 on the piece of tubing 15 is not a required element, since the opening of the weld between the tube 15 and the tube extending from the primary container will be sufficient to perform this function. However, if the pinch tube 25 on the piece of tubing 15 is not included, it will be necessary to heat seal the tube 15 after the material is supplied to the syringe 5, as will be further described below. The remainder of the device 10 is the same as the device 1 and therefore will not be further described.

An explanation of the modified version of first embodiment of the present invention will now be described. Once the device 10 is mounted to the primary container such that all connections are secure in the manner described above with regard to the first embodiment, an operator opens the weld between the piece of tubing 15 and the tube extending from the primary container to allow flow of material into the device 1. The pinch clamp 25 (if provided), which is mounted to the piece of tubing 15 is opened to allow the flow of material through the pieces of tubing 15 and 11 and into the syringe 5. If the pinch clamp 25 is not provided on the piece of tubing 15, opening the weld will allow the flow of material into the pieces of tubing 15 and 11. At this time, the syringe 5 is operated to fill the syringe with the material from the primary container.

Once a sufficient quantity of material is received into the syringe 5, the piece of tubing 15 is then closed by the pinch clamp 25 or sealed by, for example, a heat seal if the pinch clamp is not included. At this time, the cover on the needle assembly 3 is removed and the needle is inserted into a vacutainer or a sample vile. The pinch clamp 25 on the piece of tubing 7 is then opened to allow flow therethrough. Operation of the plunger of the syringe 5 forces the material out of the syringe 5, through the piece of tubing 11, through the 3-way connector 17 and into the piece of tubing 15. Since the piece of tubing 15 is closed by the pinch clamp 25 or sealed as mentioned above, the material then flows through the 3-way connector 17 again and into the piece of tubing 7. The material then flows through the needle assembly 3 and into the vacutainer or sample vile.

At this time, the needle of the needle assembly 3 can be removed from the vacutainer or sample vile to obtain a sample, which has not been contaminated. The device 10 can then be disconnected from the primary container and discarded without any contamination to the primary container. As mentioned above, it is also possible to disconnect the device 10 from the primary container prior to supplying the material to the vacutainer or sample vile. The device 10 can then be moved to a testing station where the material can be supplied to the vacutainer or sample vile to test the material.

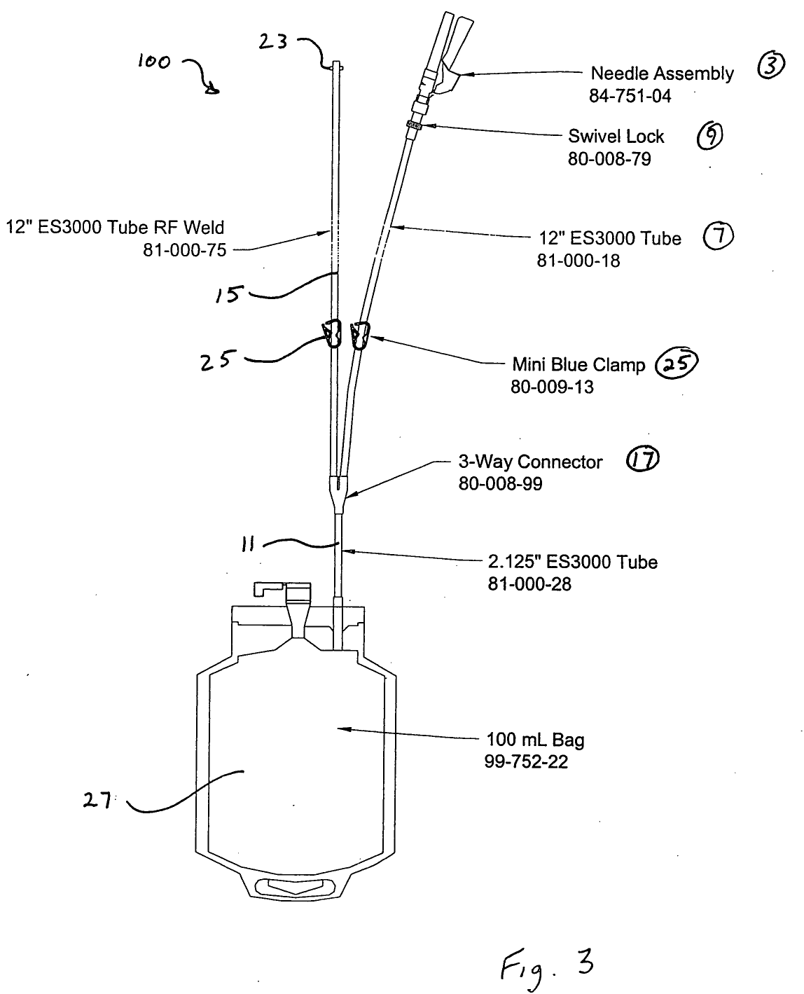

Referring to FIG. 3, a second embodiment of the present invention will be described. The device 100 includes a transfer bag 27 connected to a piece of tubing 11. The tubing 11 is connected through a 3-way connector to pieces of tubing 7 and 15. The tubing 7 is connected to a needle assembly 3 and the piece of tubing 15 has a weld 23 at an end thereof. Two pinch clamps are mounted to the pieces of tubing 7 and 15, respectively, to open and close the tubing. The piece of tubing 15 is connectable to a primary container in the same manner described above with regard to the first embodiment with a sterile docking device in order to provide an openable weld between the piece of tubing 15 and the tubing extending from the primary container.

An explanation of the second embodiment of the present invention will now be described. Once the device 100 is mounted to the primary container such that all connections are secure, an operator opens the weld between the piece of tubing 15 and the tubing extending from the primary container to allow flow of material into the device 1. The pinch clamp 25, which is mounted to the piece of tubing 15 is then opened to allow the flow of material through the piece of tubing 11 and into the transfer bag 27. Once the transfer bag is filled to the desired amount, the pinch clamp 25 is closed to close the flow of material through the piece of tubing 15. At this time, the cap on the needle assembly 3 can be removed and the vacutainer or sample vile can be attached to the needle of the needle assembly 3. The transfer bag 27 is then turned upside down and the pinch clamp 25 on the piece of tubing 7 is opened to allow flow of the material out of the transfer bag. Since the pinch clamp 25 on the piece of tubing 15 is closed, the material flows into the piece of tubing 7 toward the needle assembly 3 and into the vacutainer or sample vile attached to the needle of the needle assembly 3. Once the vacutainer or sample vile receives a desired amount of material, the pinch clamp 25 on the piece of tubing 25 is closed.

It should be noted that the pinch clamp 25 on the piece of tubing 15 is also not a required element of the second embodiment of the present invention. As mentioned above with regard to the modified version of the first embodiment, the opening of the weld between the piece of tubing 15 and the tubing extending from the primary container can be used to open the piece of tubing 15 to allow flow into the device 100. However, if the pinch clamp is not included, it will be necessary to provide a heat seal or other clamping device to close the piece of tubing 15 after the material is supplied into the transfer bag 27.

It should also be noted that the use of a vacutainer will aid the flow of material through the needle due to the suction within the vacutainer. In view of this, depending on the amount of material to be sampled, it may not be necessary to turn the transfer bag upside down. However, it is preferred to turn the transfer bag upside down, since this will limit the amount of air within the piece of tubing 7.

At this time, the needle of the needle assembly 3 can be removed from the vacutainer or sample vile to obtain a sample, which has not been contaminated. The device 100 can then be disconnected from the primary container and discarded without any contamination to the primary container.

It should be noted that the specific order of steps in also not required. As mentioned above, the device 100 can be removed from the primary container prior to supply the material into the vacutainer or sample vile. It is then possible to move the device 100 to a testing area and supply the material into the vacutainer or sample vile at the testing station.

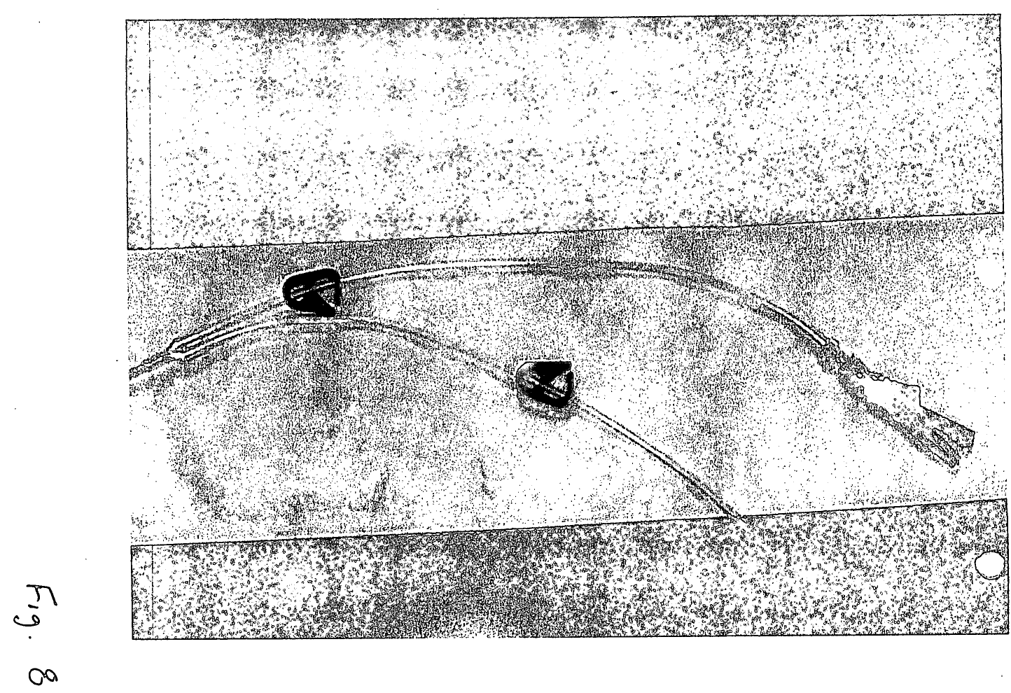

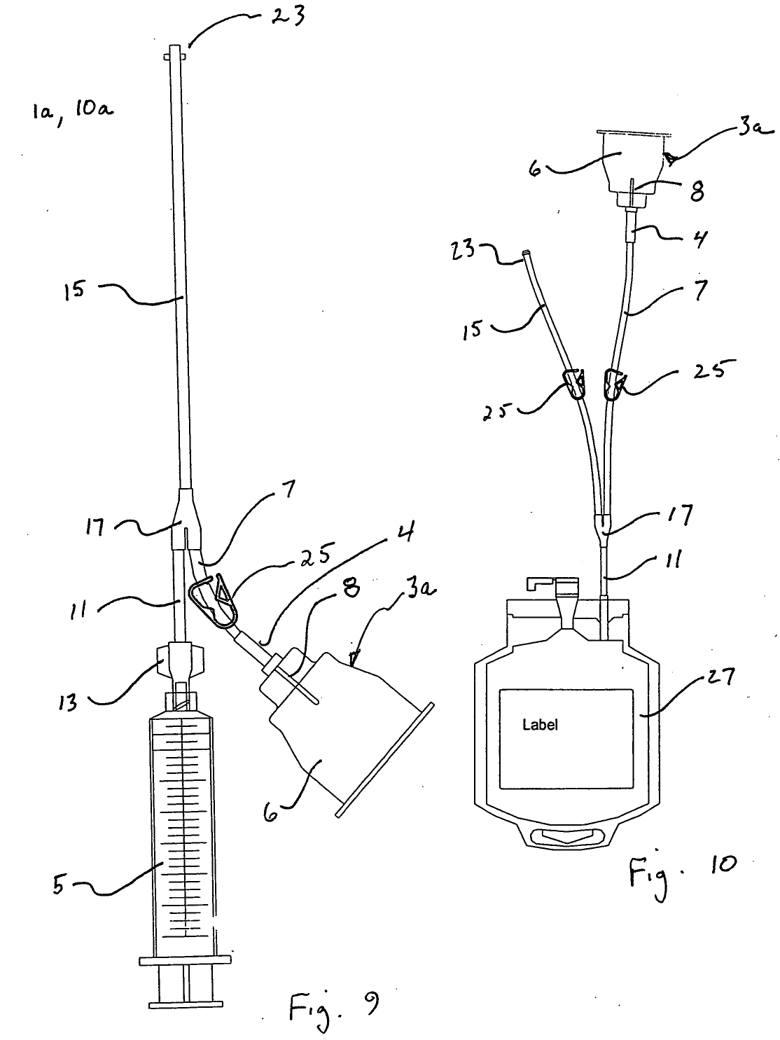

Alternative arrangements of the needle assembly of the first and second embodiments will now be described with reference to FIGS. 9 and 10. It should be noted that the same reference numerals have been used to identify the same or similar elements of the previous embodiments. Referring to FIG. 9, the device 1a, 10a can be arranged to have a fill chamber 19 as in the device 1 of FIG. 1, or can be arranged to have a pinch clamp 25 as in the device 10 of FIG. 2. The operation of the devices 1a, 10a of FIG. 9 are generally the same as the operation of the first embodiment of FIG. 1 and the modified first embodiment of FIG. 2, except that a needle assembly 3a is included in place of the needle assembly 3 of FIGS. 1 and 2. In view of this, only the needle assembly 3a will be further explained here.

Referring to FIG. 9, the swivel lock connector 9 and needle assembly 3 of FIGS. 1 and 2 is replaced with a luer adaptor 4, which supports the needle assembly 3a. The needle assembly 3a includes an adaptor cap 6 and a needle 8 supported therein. The adaptor cap is designed to fit over a culture bottle (not shown) and the needle 8 is receivable within the culture bottle. As is well known to those having ordinary skill, a culture bottle includes a rubber stopper through which the needle 8 can penetrate by pushing down on the adaptor cap 6.

Referring to FIG. 10, an alternative arrangement of the needle assembly 3 of the second embodiment of FIG. 3 will now be described. The same reference numerals have been used to identify the same or similar elements of the second embodiment. The device 100a is substantially the same as the second embodiment and it operates in generally the same manner as the second embodiment. In view of this, the operation will not be further described.

The only difference between the device 100a of FIG. 10 and the device 100 of FIG. 3 in the substitution of the needle assembly 3a for the needle assembly 3 of FIG. 3. As in the devices 1a, 10a of FIG. 9, the needle assembly 3a includes an adaptor cap 6 and needle 8, which are supported by a luer adaptor 4. The adaptor cap 6 is received over a culture bottle (not shown) and the needle penetrates a rubber stopper of the culture bottle to gain access to the interior of the culture bottle to take a sample.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A device for taking a sample of material from a primary container, comprising:
a needle assembly, said needle assembly being connectable to a container for receiving a sample of material from the primary container;
an intermediate container, said intermediate container being connected to said needle assembly through a 3-way connector; and
a length of tubing, said length of tubing being connected to said intermediate container and said needle assembly through said 3-way connector, said length of tubing being connectable to the primary container,
wherein material from the primary container is flowable through said length of tubing into said intermediate container and through said needle assembly to obtain a sample of the material into the container for receiving the sample.

2. The device according to claim 1, wherein said intermediate container is a transfer bag or a syringe.

3. The device according to claim 1, wherein said length of tubing includes a weld at an end thereof adjacent to the primary container, said weld being openable to allow flow of material from the primary container into said device.

4. The device according to claim 1, wherein said needle assembly is connected to said 3-way connector through a second length of tubing, said second length of tubing including a clamp mounted thereon, said clamp being capable of opening and closing said second length of tubing.

5. The device according to claim 1, wherein said needle assembly includes an adaptor cap and a needle, and said container for receiving the sample is a culture bottle, said adaptor cap for receiving the culture bottle therein and said needle being penetrable through a stopper of the culture bottle.

6. A method of obtaining a sample of material from a primary container into a container for receiving the sample, said method comprising the steps of:
attaching said device of claim 1 to the primary container;
opening a weld at one end of said length of tubing;
flowing the material into said intermediate container; and
flowing the material through said needle assembly and into the container for receiving the sample.

7. The method according to claim 6, further comprising the step of opening a clamp on a second length of tubing between the 3-way connector and the needle assembly to allow the material to flow through the needle assembly.

8. The method according to claim 6, wherein said intermediate container is a transfer bag or a syringe, and said step of flowing the material into the intermediate container further comprises the step of flowing the material into said transfer bag or said syringe.

9. The method according to claim 6, wherein said needle assembly includes an adaptor cap and a needle, and said container for receiving the sample is a culture bottle, said method further comprising the steps of:
placing said adaptor cap over the culture bottle; and
piercing the needle through a stopper of the culture bottle.
